(19) United States
(12) Patent Application Publication
(10) Pub. No.: US 2025/0037135 A1
(43) Pub. Date: Jan. 30, 2025

(54) METHOD AND APPARATUS FOR PROCESSING INFORMATION

(71) Applicant: SHANGHAI GOLIVETRADE NETWORK TECHNOLOGY CO., LTD., Shanghai (CN)

(72) Inventor: Jing LIU, Shanghai (CN)

(21) Appl. No.: 18/272,594

(22) PCT Filed: Dec. 30, 2021
(86) PCT No.: PCT/CN2021/143410

§ 371 Date: Jul. 17, 2023

(30) Foreign Application Priority Data
Jan. 18, 2021 (CN) 202110064682.2

(51) Int. Cl. G06Q 20/40; G06Q 20/06

(52) U.S. Cl. CPC G06Q 20/405; G06Q 20/065; G06Q 20/407

(57) ABSTRACT

An information processing method includes: after receiving target information from a first party, a server side determining candidate second parties of first stage by matching entry information of a plurality of second parities with the target information; after receiving a first service support information form a candidate third party of first stage, the server side determining a candidate third object of second stage by matching the first service support information with the entry information of the candidate second parties of first stage; the server side receiving a first response message generated by the candidate second parties of first stage, and determining a candidate second party of second stage by matching the first response message with the target information; and the server side receiving a second party of third stage determined from the candidate second parties of second stage, and determining a target second party.

This application claims priority to Chinese patent application No. 202110064682.2 filed with China National Intellectual Property Administration on Jan. 18, 2021 and entitled “Method and Apparatus For Processing Information”, which is incorporated herein by reference in its entirety.

### TECHNICAL FIELD

The present application relates to the field of data processing technology, and more particularly, to an information processing method and an information processing apparatus.

### BACKGROUND

In the field of data processing technology, there are various application scenarios in which information are matched and screened so as to determine information or parties that match target information. For example, in a scenario of bidding, i.e., in a scenario where a plurality of bidders bid to buy or sell for the demand of a single tenderee, there is requirement to determine a bidder that matches tender information.

In the bidding scenario, in order to make the tenderee have more objective understanding of the bidder as well as to realize effective matching and execution of resources, some bidding systems have appeared in the related technology, however, the bidding systems in the related technology generally only serve two parties with direct relationship, i.e., the bidder and the tenderee, it is difficult for multiple parties in one or more industrial chains to cooperate efficiently and accurately to realize single or multiple biddings through information interchange and collaboration. And the bidding systems in the related technology cannot process a large amount of bidding information submitted by a large number of candidate bidders, so they cannot realize the bidding for a single tenderee in the case of a large number of candidate bidders, such as thousands, tens of thousands or hundreds of thousands of candidate bidders directly participating in the bidding, together with more candidate relevant parties indirectly participating in the same or multiple biddings. And meanwhile, they cannot realize the bidding in scenarios where a large number of tenderees initiate biddings at high frequencies or at the same time.

There are no effective solutions proposed so far against the problem of the low processing efficiency of bidding data in the bidding systems in the related technology, so it is difficult to accurately determine a bidder that matches tender demand information.

### SUMMARY

At least part of embodiments of the present application provide an information processing method and apparatus to solve the problem that bidding data are processed low-efficiently in the related technology and it is difficult to accurately determine a bidder that matches tender demand information.

An embodiment of the present application provides an information processing method, comprising: after receiving target information sent by a client side corresponding to a first party, a server side obtaining a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second parties comprises at least identity information of the plurality of second parties and information of the plurality of second parties associated with demand specs of the target service, the candidate third parties indicates parties associated with the first party and/or the second parties, and the candidate third parties are intended to provide service support for the target service; after receiving first service support information sent by the client sides corresponding to the candidate third parties of first stage, the server side obtaining a second determination result by matching the first service support information with the entry information of the candidate second parties of first stage and determining candidate third parties corresponding to matched first service support information as candidate third parties of second stage, and sending the second determination result to client sides corresponding to the candidate second parties of first stage; the server side obtaining a third determination result by receiving first response message generated by the candidate second parties of first stage based on the first service support information, matching the first response message with the target information, and determining candidate second parties corresponding to matched first response message as candidate second parties of second stage, and sending the third determination result to the client side corresponding to the first party; and the server side receiving second parties of third stage determined by the client side corresponding to the first party from the candidate second parties of second stage, and determining a target second party from the second parties of third stage based on a second service support information sent by the third parties of second stage.

Optionally, the server side receiving the second parties of third stage determined by the first party from the candidate second parties of second stage, and determining the target second party from the second parties of third stage based on the second service support information sent by the third parties of second stage comprises: the server side obtaining a fourth determination result by receiving second parties of third stage determined by the client side corresponding to the first party from the candidate second parties of second stage, and sending the fourth determination result to client sides corresponding to the second parties of third stage; the server side receiving second response message sent by the second parties of third stage and sending the second response message to client sides corresponding to the candidate third parties of second stage; the server side receiving second service support information sent by the candidate third parties of second stage in response to the second response message and sending the second service support information to the second parties of third stage; and the server side receiving confirmation information sent by a client side corresponding to at least one second party of the second parties of third stage and determining the at least one second party sending the confirmation information as the target second party.

Optionally, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: the server side receiving entry information sent by client sides corresponding to a plurality of parties, the plurality of parties comprising at least: the first party, the plurality of second parties and a plurality of third parties, wherein the entry information comprises at least identity information of the plurality of parties and information of the plurality of parties associated with demand specs of the target service; and the server side verifying the entry information of the plurality of parties and obtaining an information set consisting of entry information of the plurality of parties that pass verification, and sending the information set to a client side corresponding to each of the plurality of parties.

Optionally, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: the server side receiving identity information sent by client sides corresponding to a plurality of parties and receiving device information uploaded via Internet by sensing devices associated with the plurality of parties, wherein the plurality of parties comprises at least: the first party, the plurality of second parties, and a plurality of third parties, wherein the device information indicates information associated with demand specs of the target service; and the server side obtaining entry information of the plurality of parties by verifying identity information of each party of the plurality of parties and the device information uploaded by the sensing devices associated with each party of the plurality of parties, and sending an information set consisting of the entry information of the plurality of parties to client sides corresponding to each of the plurality of parties.

Optionally, during determining the second parties of first stage, determining the second parties of second stage and determining the second parties of third stage, a first notification message is sent to the client side corresponding to the first party and to client sides corresponding to the second parties in each stage that entered a next stage, respectively, and a second notification message is sent to client sides corresponding to the second parties in each stage that failed to enter the next stage, respectively; wherein the first notification message comprises information about all second parties of a current stage that entered the next stage, and the second notification message indicates that the second party in the current stage failed to enter the next stage.

Optionally, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: the server side receiving entrustment information of the first party and/or the plurality of second parties and determining, based on the entrustment information, a fourth party corresponding to the first party and/or a fifth party corresponding to the plurality of second parties, respectively; and during the first stage, the second stage, and the third stage, in a case that the server side receives an entrustment instruction of the first party, the fourth party processes information to be processed the first party on behalf of the first party, and in a case that the server side receives an entrustment instruction from one of the second parties, the fifth objet processes information to be processed by the one of the second parties on behalf of the one of the second parties.

Optionally, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: receiving, through an independent financial service provider, digital currency deposited by the plurality of second parties; and refunding the digital currency deposited by the second parties in each stage that failed to enter a next stage during determining the second parties of first stage, determining the second parties of second stage, and determining the second parties of third stage.

Optionally, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises receiving, through an independent financial service provider, digital currency deposited by the first party; after the server side receiving the second party of third stage determined by the client side corresponding to the first party from the candidate second party of second stage, and determining the target second party from the second party of third stage based on the second service support information sent by the third party of second stage, the method further comprises: during the target second party providing the target service indicated by the target information, determining whether behavior of the first party complies with the first predetermined rules and determining whether the target second party complies with the second predetermined rules; in a case that the behavior of the first party complies with the first predetermined rules, paying, through the independent financial service provider, digital currency deposited by the target second party that fails to comply with the second predetermined rules to the first party and refunding through the independent financial service provider the digital currency deposited by the target second party that complies with the first pre-determined rules; and in a case that the behavior of the first party fails to comply with the first pre-determined rules, refunding through the independent financial service provider the digital currency deposited by the target second party that complies with the first pre-determined rules, and paying through the independent financial service provider the digital currency deposited by the first party to the target second party that complies with the first predetermined rules.

Optionally, after the server side receiving the second parties of third stage determined by the client side corresponding to the first party from the candidate second parties of second stage, and determining the target second party from the second parties of third stage based on the second service support information sent by the third parties of second stage, the method further comprises: the server side receiving demand information sent by the first party and/or the target second party and determining a sixth party based on the demand information such that the sixth party provides service indicated by the demand information; and the server side receiving supply information sent by the first party and/or the target second party and determining a seventh party based on the supply information such that service indicated by the supply information is provided for the seventh party.

Optionally, after receiving information sent by a target client side, the server side identifies a first language in which the received information is expressed and determines whether the first language is a predetermined language, wherein the target client side is a client side corresponding to at least one of the following parties: the first party, the second party and the third party; in a case that the first language is not the predetermined language, the server side converting the received information into information expressed in the predetermined language and obtaining meaning of the converted information through semantic understanding; after obtaining the information to be sent to the target client side, the server side converting the information to be sent to the target client side into information expressed in the first language and sending the converted information to be sent to the target client side, and sending the converted information to the target client side.

According to another embodiment of the present application, a bidding apparatus is provided. The bidding apparatus comprises:
a first determination unit, configured to receive target information sent by a client side corresponding to a first party through a server side, and to obtain a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second parties comprises at least identity information of the plurality of second parties and information of the plurality of second parties associated with the demand specs of the target service, the candidate third parties indicates parties associated with the first party and/or the plurality of second parties, and the candidate third parties are intended to provide service support for the target service;
a second determination unit, configured to obtain, after receiving first service support information sent by client sides corresponding to the candidate third parties of first stage, a second determination result by matching the first service support information with entry information of the candidate second parties of first stage and determining candidate parties corresponding to matched first service support information as candidate third parties of second stage, and to send the second determination result to client sides corresponding to the candidate second parties of first stage;
a third determination unit, configured to obtain a third determination result by receiving, through the server side, first response message generated by the candidate second parties of first stage based on the first service support information, matching the first response message with the target information and determining candidate second parties corresponding to matched first response message as candidate second parties of second stage, and sending the third determination result to the client side corresponding to the first party; and
a fourth determination unit, configured to receive, by the server side, a second parties of third stage determined by the client side corresponding to the first party from the candidate second parties of second stage, and to determine a target second party from the second parties of third stage based on second service support information sent by the third parties of second stage.

Another embodiment of the present invention provides a non-volatile storage medium, the non-volatile storage medium comprising a stored program, wherein the program, when executed, controls a device on which the non-volatile storage medium is located to perform an information processing method.

According to another aspect of embodiments of the present invention, there is further provided an electronic apparatus comprising a processor and a memory; computer readable instructions are stored in the memory, and the processor is configured to execute the computer readable instructions, wherein the computer readable instructions performs an information processing method when run.

By the present application, the following operations are implemented: after receiving target information sent by a client side corresponding to a first party, the server side obtaining a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second party comprises at least identity information of the plurality of second party and information of the plurality of second parties associated with demand specs of the target service, the candidate third parties indicates parties associated with the first party and/or the second party, and the candidate third parties are intended to provide service support for the target service; after receiving first service support information sent by the client sides corresponding to the candidate third parties of first stage, the server side obtaining a second determination result by matching the first service support information with the entry information of the candidate second parties of first stage and determining a candidate third parties corresponding to matched first service support information as candidate third parties of second stage, and sending the second determination result to client sides corresponding to the candidate second parties of first stage; the server side obtaining a third determination result by receiving first response message generated by the candidate second parties of first stage based on the first service support information, matching the first response message with the target information, and determining candidate second parties corresponding to matched first response message as candidate second parties of second stage, and sending the third determination result to the client side corresponding to the first party; and the server side receiving second parties of third stage determined by the client side corresponding to the first party from the candidate second parties of second stage, and determining a target second party from the second parties of third stage based on a second service support information sent by the third parties of second stage. Through such a technical solution, by collecting information from multiple parties and collaboratively processing their interaction information, it achieves effect of efficiently and accurately identifying a bidder that matches tender demand information of single or multiple bidding scenarios.

### BRIEF DESCRIPTION OF THE DRAWINGS

The accompanying drawings, which form part of this application, are intended to provide a further understanding of this application, and the schematic embodiments of this application and the description thereof are used to explain this application and cannot be construed as a limitation on the present application. In the accompanying drawings:

FIG. 1 illustrates a flow chart of an information processing method according to an embodiment of the present application; and

FIG. 2 illustrates a schematic diagram of a bidding apparatus according to an embodiment of the present application.

### DETAILED DESCRIPTION

It should be noted that the embodiments and the features in the embodiments of the present application can be combined with each other without conflict. The present application will be described in detail below with reference to the accompanying drawings and in conjunction with the embodiments.

In order to enable one of ordinary skill in the art to understand the present application scheme better, solutions of the embodiments of the present application will be described hereinafter clearly and completely in conjunction with the drawings accompanying the present application. Obviously, the embodiments described are only a part of the embodiments of the present application, and not all of them. Based on the embodiments of the present application, all other embodiments obtained by one of ordinary skill in the art without creative works shall fall within the scope of protection of the present application.

It should be noted that the terms “first”, “second”, etc. in the specification and claims of the present application and the drawings accompanying the present application above are intended to distinguish similar parties and are not used to describe a particular order or sequence. It should be understood that the used words are interchangeable, where appropriate, for the purposes of the embodiments of the present application described herein. In addition, the terms “comprises” and “has”, and any variations thereof, are intended to cover non-exclusive inclusion, e.g., a process, method, system, product, or apparatus comprising a series of steps or units need not be limited to those steps or units that are clearly listed, and may comprises those steps or units that are not clearly listed. or that are inherent to those processes, methods, products, or devices.

According to an embodiment of the present application, an information processing method is provided.

### Embodiment One

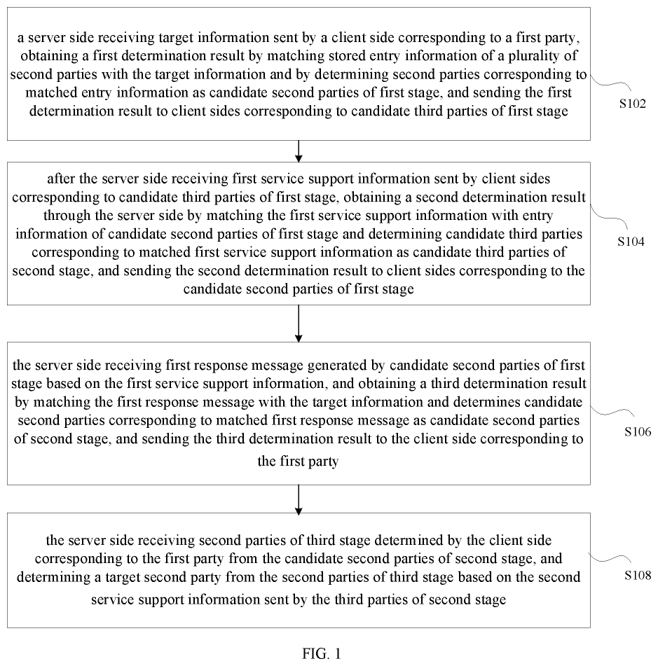

FIG. 1 illustrates a flow chart of an information processing method according to an embodiment of the present application. As illustrated in FIG. 1, the method comprising followings.

Step S102, the server side receives target information sent by a client side corresponding to a first party, obtains a first determination result by matching stored entry information of a plurality of second parties with the target information and by determining second parties corresponding to matched entry information as candidate second parties of first stage, and sends the first determination result to client sides corresponding to candidate third parties of first stage, wherein the target information is intended to describe demand specs of target service, the entry information of the plurality of second party comprises at least identity information of the plurality of second party and information of the plurality of second party associated with the demand specs of the target service, the candidate third parties indicates parties associated with the first party and/or the plurality of second parties, and the candidate third parties are intended to provide service support for the target service.

It should be noted that the server side interacts with client sides corresponding to a plurality of parties for information interchange, and the plurality of parties comprise at least a first party, a second party, and a third party.

The server side may refer to a cloud server system or a local server system, the client side may be installed in cell phones, PCs, portable wearable devices, and other electronic devices, and the client side may further be a web end, and the first party, the second party, and the third party may realize information interaction with the server side through the web end.

In an optional embodiment, in the bidding activity, the first party is a tenderee, the second party is a bidder, and the third party is a relevant party associated with the tenderee and the bidders, and a bidding system consists of a server side, a web end or a client side corresponding to the tenderee, a web end or a client side corresponding to the bidder, and a web end or a client side corresponding to the relevant parties. Through the bidding system, multiple users within an industry or across industry can collaborate through information interaction and participate in one bidding at the same time, and a bidder matching the tender information can be determined efficiently, accurately, and with a high degree of automation.

For example, in the bidding activity, the target information is tender information, which is intended to describe multi-dimensional demand specs of the tender, and after the tenderee inputs the tender information through a client side or web end, the client side or the server side sends the tender information to the server side through the network. The server side analyzes and compares the bidding entry information of a plurality of bidders based on the tender information, screens all candidate bidders of first stage, and notifies the screening result to the client sides or web ends of all the candidate bidders of first stage, and at the same time, notifies the screening result to the client sides or web ends of all other candidate relevant parties of first stage which are authorized to obtain the same tender information, and notifies the screening result to the client side or the web end of the tenderee.

It should be noted that relevant parties may be users directly participating in the bidding, comprising but not limited to an upstream purchaser of the tenderee, a downstream supplier of the bidder, a guarantor of the tenderee, a guarantor of the bidder, and a transaction credit insurance underwriter of the tenderee.

There is a situation where the tenderee, the bidder and the relevant party are in different regions and use different languages for information interaction. Optionally, in the information processing method according to an embodiment of the present application, after the server side receives information sent by a target client side, it identifies a first language used in the received information and determines whether the first language is a predetermined language, wherein the target client side indicates a client side corresponding to at least one of the following parties: the first party, the second party, and the third party; in a case that the first language is not the predetermined language, the server side converts the received information into information expressed in the predetermined language, and obtains meaning of the converted information through semantic understanding; after the server side obtains information to be sent to the target client side, it converts the information to be sent to the target client side into information expressed in the first language and then send the converted information to the target client side.

With this embodiment, not only multiple users, such as a tenderee, a bidder, an upstream of the tenderee, and a downstream of the bidder, are enabled to indirectly participate in one bidding at the same time, but also the problem that it is difficult for the tenderee to select the bidders from different countries, different time zones, different languages, and different cultures for each single bidding is solved, and thereby achieving an effect that a supply chain for each single bidding is established, integrated and managed at a global scale.

For example, in a case that the target client side is a client side corresponding to the tenderee, after the tenderee inputs tender information to the target client side, the target client side sends the tender information to the server side through the network, and in a case that the tender information is in a different language from the server side, the server side translates the tender information, obtains meaning of the tender information through semantic understanding, and analyzes and compares bidding entry information of multiple bidders based on the tender information so as to screen out all candidate bidders of first stage.

Optionally, in the information processing method according to embodiment one of the present application, after receiving the target information sent by the client side corresponding to the first party, and before the server side obtaining the first determination result by matching stored entry information of a plurality of second parties with the target information and determining second parties corresponding to matched entry information as candidate second parties of first stage, the method further comprises: the server side receiving entry information sent by client sides corresponding to a plurality of parties, wherein the plurality of parties comprises at least a first party, a plurality of second parties, a plurality of third parties, and the entry information comprises at least identity information of the plurality of parties and information of the plurality of parties associated with demand specs of the target service; and the server side verifies the entry information of the plurality of parties so as to obtain an information set consisting of entry information of parties that has been verified, and sends the information set to a client side corresponding to each of the plurality of parties, respectively.

It should be noted that the entry information of each party not only comprises identity information that indicates the party participating in the bidding activity as an tenderee, a bidder or a relevant party, but also comprises information related to the demand specs of the target service, for example, at least legal registration data, product types and capacity, intellectual property reserves, certification and testing reports, historical honors and other information of the party. The server side sends entry information set of the plurality of parties to respective client sides corresponding to the plurality of parties so as to facilitate bidding decision of respective party.

Optionally, in the information processing method according to embodiment one of the present application, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: the server side receives identity information sent by respective client side corresponding to the plurality of parties, and receives device information uploaded by sensing devices associated with the plurality of parties through the Internet, wherein the plurality of parties comprises at least: a first party, a plurality of second parties, and a plurality of third parties, wherein the device information indicates information associated with demand specs of the target service; the server side obtains respective entry information of the plurality of party by verifying the identity information of each of the plurality of parties and the device information uploaded by the sensing devices associated with each of the plurality of parties, and sending an information set consisting of the entry information of the plurality of parties to respective client side corresponding to the plurality of parties.

It should be noted that, in order to reduce workload of users filling in entry information through the client side or web end, and difficulty in obtaining production information in real time, in an embodiment of the present application, sensing devices may be installed on production equipment of the tenderees, the bidders and the relevant parties to monitor production data of the production equipment in real time, and the server side is authorized to obtain the production data. In other words, the production data collected by the sensor devices can be sent to the server side via the Internet, and the production data can be matched with identity information filled in by corresponding party to obtain respective entry information of the plurality of parties, and information set of entry information of the plurality of parties may be sent to respective client side of the plurality of parties, so as to facilitate bidding decision of each of the plurality of parties.

The embodiment one facilitates reading and analysis of the multidimensional information of a large number of bidders, as well as matching and screening of the multidimensional information of the tender information with the multidimensional information of a large number of bidders.

Step S104, after the server side receives first service support information sent by client sides corresponding to candidate third parties of first stage, a second determination result is obtained through the server side by matching the first service support information with entry information of candidate second parties of first stage and determining candidate third parties corresponding to matched first service support information as candidate third parties of a second stage, and the second determination result is sent to client sides corresponding to the candidate second parties of first stage.

For example, in bidding activity, the first service support information may be co-participation instruction information. After the relevant party of first stage inputs co-participation instruction information through a client side or a web end, the client side or the server side sends the co-participation instruction information to the server side. In a case that language of the co-participation instruction information is different from language of the server side, the server side translates the co-participation instruction information, obtains meaning of the co-participation instruction information through semantic understanding, screens candidate relevant parties successfully entering a second stage from relevant parties of first stage according to the co-participation instruction information, and notifies screening result to the client sides or web ends of all the candidate bidders of first stage.

Step S106, the server side receives first response message generated by candidate second parties of first stage based on the first service support information, and obtains a third determination result by matching the first response message with the target information and determines candidate second parties corresponding to matched first response message as candidate second parties of second stage, and sends the third determination result to the client side corresponding to the first party.

For example, in bidding activity, the first response message is bidding response message, and after obtaining candidate relevant parties of second stage, a candidate bidder of first stage generate a bidding response message based on the participation tender information, and obtain operation instruction information of second stage based on the bidding response message, and after inputting operation instruction information of second stage through the corresponding client side or web end, the client side or the server side sends the operation instruction information of second stage to the server side through the network. If language of the operation instruction information of second stage is different from language of the server side, the server side translates the operation instruction information of second stage, obtains meaning of the operation instruction information of second stage through semantic understanding, screens candidate bidders of second stage based on the operation instruction information of second stage, and notifies the screening result to all client sides or web ends of candidate bidders that successfully enter the second stage. The server side further triggers an independent financial service provider to refund the bidding deposit to the accounts of bidders that fail to enter the second stage, and then notifies the screening result to the client sides or web ends of the bidders that enters the second stage and to the client sides or the web end of the tenderee.

It should be noted that the process of analyzing and screening corresponds to at least two stages, i.e., candidate bidders and candidate relevant parties can be obtained through two rounds of analyzing and screening. And further, candidate bidders and candidate relevant parties may be obtained through multiple rounds of analyzing and screening.

Step S106, the server side receives second parties of third stage determined by the client side corresponding to the first party from the candidate second parties of second stage, and determines a target second party from the second parties of third stage based on the second service support information sent by the third parties of second stage.

For example, in bidding activity, the second party of third stage may be an interested bidder, and the second service support information may be final co-operation participation operation instructions.

Optionally, in the information processing method according to the embodiment of the present application, the server side receiving the second parties of third stage determined by the first party from the candidate second parties of second stage, and determining the target second party from the second parties of third stage based on the second service support information sent by the third parties of second stage comprising: the server side obtaining a fourth determination result by receiving a second parties of third stage determined by the client side corresponding to the first party from the candidate second parties of second stage, and sending the fourth determination result to client sides corresponding to the second parties of third stage; the server side receiving a second response message sent by the second parties of third stage, and sending the second response message to the client side corresponding to the candidate third parties of second stage; the server side receiving a second service support information sent by the candidate third parties of second stage in response to the second response message, and sending the second service support information to the client side corresponding to the candidate third parties of second stage; the server side receiving the second service support information sent by the candidate third parties of second stage and sending the second service support information to the second parties of third stage; the server side receiving confirmation information sent by a client side corresponding to at least one second party in the second parties of third stage and determining the at least one second party sending the confirmation information as a target second party.

For example, in bidding activity, the tenderee identifies an interested bidder from the candidate bidders of second stage and inputs first stage operation instruction information through the corresponding client side or web end, and the client side or the server side sends the first stage operation instruction information of the tenderee to the server side through the network. The server side translates the first stage operation instruction information, obtains meaning of the first stage operation instruction information through semantic understanding, screens interested bidders who successfully enter the third stage based on the first stage operation instruction information and notifies screening result to the client sides and web ends of all the interested bidders who successfully enter the third stage, as well as notifies the client sides and web ends of all the candidate bidders who fail to enter the third stage. The server side further triggers an independent financial service provider to refund the bidding deposit to the accounts of bidders that fail to enter the third stage, and notifies the screening result to the client side and web end of all candidates relevant parties that enter the second stage.

Further, interested bidders that successfully enter the third stage input final stage operation instruction information through the corresponding client side or web end, the client side and web end send the final stage operation instruction information to the server side through the network, the server side sends the final stage operation instruction to the candidate relevant parties which successfully enter the second stage, the candidate relevant parties of the second stage send final co-participation operation instruction information through the corresponding client side and the web end. In a case that the final co-participation operation instruction is different from the server side in language, the server side translates the final co-participation operation instruction, obtains meaning of the final co-participation operation instruction through semantic understanding, screens interested parties that successfully enter the third stage based on the final co-participation operation instruction, and notifies the screening result to all interested parties that successfully enter the third stage The server side further triggers an independent financial service provider to refund the bidding deposit to accounts of all bidders that fail to enter the third stage.

Through this implementation, efficiency of multiple parties participating in the same bid is greatly improved, and a large number of tendering and bidding demand can be supported, and matching and trading of production factors are achieved, success rate of screening is significantly improved, and management costs is reduced at the same time, while ensuring fairness of the bidding results.

Further, after the bidding confirmation information, i.e., the final stage operation instruction, is inputted through the corresponding client side and the corresponding web end, the client side and the web end send input final stage operation instruction to the server side via the network, and in a case that the final stage operation instruction is different from the server side in language, the server side translates the final stage operation instruction and obtains meaning of the final stage operation instruction through semantic understanding, screens a target bidder based on the final stage operation instructions, and notifies the client side and the web end of the issuing bidder, the issuing bidder sends final operation instruction to the server side, the server side sends final bidding result to the client side and web end of at least one or more successful bidders, and notifies the final bidding result to the client side and web end of all unsuccessful bidders at the same time. The server side further triggers the independent financial service provider to refund bidding deposit to the accounts of all the remaining unsuccessful bidders.

Optionally, in the information processing method according to the embodiment of the present application, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: receiving digital currency deposited by the plurality of second parties through an independent financial service provider; and during determining the second party of first stage, determining second parties of second stage, and determining second parties of third stage, returning the digital currency deposited by the second parties in each stage that does not enter the next stage through the independent financial service provider.

It should be noted that, in bidding activity, in order to ensure that after the bidding, transaction can be conducted as promised, margin of multiple bidders is collected in advance through an independent financial service provider. For example, multiple bidders entrust an independent financial service provider in advance to make deductions and determine a recipient, and the independent financial service provider collects and stores the margin of multiple bidders before the tenderee release the tender, and promptly refunds the margin of bidders who fails in each stage of the bidding, thereby achieving automatic collection, escrow and refund of margin during the bidding.

Optionally, in the information processing method according to the embodiment of the present application, after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises: receiving digital currency deposited by the first party through an independent financial service provider; after the server side receiving the second parties of third stage determined by the client side corresponding to the first party from the candidate second parties of second stage and determining the target second parties from the second parties of third stage based on the second service support information sent by the third parties of second stage, the method further comprises: determining whether behavior of the first party complies with a first predetermined rules and determining whether the target second parties complies with the second predetermined rules during the target second parties providing the target service indicated by the target information; paying the digital currency deposited by the target second party that does not comply with the second predetermined rules to the first party through the independent financial service provider, and refunding the digital currency deposited by the target second party that complies with the first predetermined rules through the independent financial service provider in a case that the behavior of the first party complies with the first predetermined rules; in a case that the first party's behavior does not comply with the first predetermined rules, refunding the digital currency deposited by the target second party that complies with the first predetermined rules through the independent financial service provider, and paying the digital currency deposited by the first party to the target second party that complies with the first predetermined rules through the independent financial service provider.

For example, in bidding activity, both the tenderee and the successful bidder input promise fulfillment information to the server side through the client side and the web end, and the server side screens at least one or more promise-keeping bidders and determines whether the tenderee keeps its promise by comparing the promise fulfillment information, and immediately refunds the bidding margin to the account of a promise-keeping party, and pays the bidding margin of a defaulting party to a promise-keeping party, and notifies the client side and the web end of the promise-keeping party and the defaulting party at the same time, thereby achieving transaction escrow of the whole process of bidding issuing and bidding.

There exists a situation where it is difficult for the tenderee or the bidder to process information in a timely manner during the bidding, optionally, in the information processing method according to the embodiments of the present application, after the server side receiving the second parties of third stage determined by the client side corresponding to the first party from the candidate second parties of second stage, and determining the target second party from the second parties of third stage based on the second service support information sent by the third parties of second stage, the method further comprises: the server side receiving entrustment information of the first party and/or the plurality of second parties, and determines a fourth party corresponding to the first party and/or fifth parties corresponding to the plurality of second parties, respectively, based on the entrustment information; of first stage, the second stage and the third stage, in a case that the server side receives the entrustment instruction of the first party, the fourth party processes information to be processed by the first party on behalf of the first party, and in a case that the server side receives the entrustment instruction of the second party, the fifth parties processes information to be processed by the second party on behalf of the second parties.

For example, the tenderee and the bidder may send entrustment operation instruction to the server side through the client side or the web end, and in a case that the entrustment operation instruction is different from the server side in language, the server side translates the entrustment operation instruction, obtains meaning of the entrustment operation instruction through semantic understanding, and converts the entrustment operation instruction into information in the language used by multiple agents, and determine a first interested agent as the agent to participate in the whole process of releasing tender and bidding on behalf of the tenderee and the bidder.

Through this embodiment, not only the problem that it is difficult for bidders to process information in time during the bidding, but also the tenderee and the bidder are from different countries or different time zones can participate in the bidding through their agents.

Optionally, in the information processing method according to the embodiment of the present application, after the server side receiving second parties of third stage determined by the client side corresponding to the first party from the candidate second parties of second stage, and determining the target second party from the second parties of third stage based on the second service support information sent by the third parties of second stage, the method further comprises: the server side receiving the demand information sent by the first party and/or the target second party, and determining a sixth party based on the demand information such that the sixth party performs service indicated by the demand information; and the server side receiving supply information sent by the first party and/or the target second party, and determining a seventh party based on the supply information such that service indicated by the supply information is provided for the seventh party.

For example, both the tenderee and the successful bidder input production factor supply information and production factor demand information to the server side through their respective client side and web end, and the server side verifies all the production factor information and releases verified production factor information to client sides and web ends of supply parties and demand parties, and the supply parties can choose to provide production factors to the tenderee and the successful bidder based on the production factor information, and the demand parties can choose to obtain the production factors from the tenderee and the successful bidder based on the production factor information, i.e., the supply parties and the demand parties can realize transaction of production factor between the tenderee and the successful bidder through the production factor supply information and the production factor demand information released by the server side, for example, income and expenditure, deposited value and refund in the transactions may be realized through an independent financial service provider.

In addition, the tenderee and the successful bidder can further transact with indirect relevant parties through the server side, for example, indirect relevant parties may be other users who can provide complementary services, such as certification and testing service providers, design service providers, intellectual property service providers, etc. Unlike directly related parties, indirectly related parties provide services through releasing demand information by the tenderee and the successful bidder via the server side, rather than participating in bidding directly and establishing relationships with the bidders and the tenderees by registering information before bidding

With this embodiment, transaction and integration of various production factors within one or more industry chains associated with the bidding is realized.

In order to keep each user informed of bidding status, optionally, in the information processing method according to this application embodiment, during determining the second parties of first stage, determining the second parties of second stage, and determining the second parties of third stage, a first notification message is sent to the client side corresponding to the first party and the client sides corresponding to the second parties in each stage that enters the next stage, respectively, and a second notification message is sent to the client sides corresponding to the second parties in each stage that does not enter the next stage, respectively, wherein the first notification message comprises information about all the second parties of a current stage that enter the next stage, and the second notification message is intended to indicate that the second party in the current stage that fails to enter the next stage.

For example, at each stage of the bidding process during the bidding activity, the tenderee, the successful bidders passing the screening, the unsuccessful bidders failing to pass the screening, and relevant parties with authority to be informed of the screening result are notified.

In addition, the server side verifies, stores and manages operation instruction input by all parties so as to verify, store and manage initiation, check, establishment, suspension and termination of proxy relationships and association relationships among all parties, as well as to verify, store and manage grant, confirmation, suspension and termination of corresponding authority.

The information processing method according to this application embodiment, after receiving target information sent by a client side corresponding to a first party, the server side obtaining a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second party comprises at least identity information of the plurality of second party and information of the plurality of second parties associated with demand specs of the target service, the candidate third parties indicates parties associated with the first party and/or the second party, and the candidate third parties are intended to provide service support for the target service; after receiving first service support information sent by the client sides corresponding to the candidate third parties of first stage, the server side obtaining a second determination result by matching the first service support information with the entry information of the candidate second parties of first stage and determining a candidate third parties corresponding to matched first service support information as candidate third parties of second stage, and sending the second determination result to client sides corresponding to the candidate second parties of first stage; the server side obtaining a third determination result by receiving first response message generated by the candidate second parties of first stage based on the first service support information, matching the first response message with the target information, and determining candidate second parties corresponding to matched first response message as candidate second parties of second stage, and sending the third determination result to the client side corresponding to the first party; and the server side receiving second parties of third stage determined by the client side corresponding to the first party from the candidate second parties of second stage, and determining a target second party from the second parties of third stage based on a second service support information sent by the third parties of second stage. Thereby, the problem that bidding data is processed at a low efficiency and it is difficult to a bidder matching tender demand information is solved. By collecting information from multiple parties and collaboratively processing their interaction information, effect of efficiently and accurately determining bidders that match the tender demand information of single or multiple bidding scenarios is achieved.

It should be noted that the steps illustrated in the flowchart of the accompanying drawings may be performed in a computer system such as a set of computer-executable instructions, and that, although a logical sequence is illustrated in the flowchart, the steps illustrated or described may be performed in an order different from that illustrated herein in some cases.

### Embodiment Two

The embodiment two of the present application further provides a bidding apparatus, and it should be noted that the bidding apparatus according to the embodiment of the present application can be configured to perform the information processing method according to the present application embodiment. The following is a description of the bidding apparatus according to the present application embodiment.

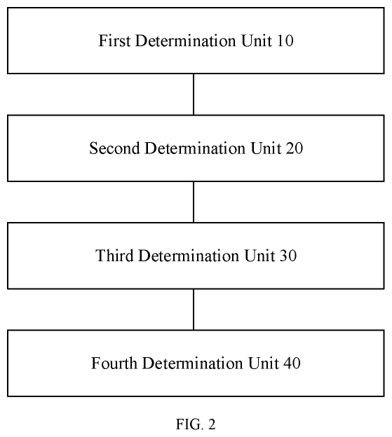

FIG. 2 is a schematic diagram of a bidding apparatus according to an embodiment of the present application. As illustrated in FIG. 2, the apparatus comprises:
a first determination unit 10, configured to receive target information sent by a client side corresponding to a first party through a server side, and to obtain a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second parties comprises at least identity information of the plurality of second parties and information of the plurality of second parties associated with the demand specs of the target service, the candidate third parties indicates parties associated with the first party and/or the plurality of second parties, and the candidate third parties are intended to provide service support for the target service.
a second determination unit 20, configured to obtain, after receiving first service support information sent by client sides corresponding to the candidate third parties of first stage, a second determination result by matching the first service support information with entry information of the candidate second parties of first stage and determining candidate parties corresponding to matched first service support information as candidate third parties of second stage, and to send the second determination result to client sides corresponding to the candidate second parties of first stage;
a third determination unit 30, configured to obtain a third determination result by receiving, through the server side, first response message generated by the candidate second parties of first stage based on the first service support information, matching the first response message with the target information and determining candidate second parties corresponding to matched first response message as candidate second parties of second stage, and sending the third determination result to the client side corresponding to the first party; and
a fourth determination unit 40, configured to receive, by the server side, a second parties of third stage determined by the client side corresponding to the first party from the candidate second parties of second stage, and to determine a target second party from the second parties of third stage based on second service support information sent by the third parties of second stage.

In the bidding apparatus according to the embodiment of the present application, after the first determination unit 10 receives, through the server side, the target information sent by the client side corresponding to the first party, the first determination unit 10 obtains a first determination result by matching the stored entry information of the plurality of second parties with the target information and determining the second party corresponding to the matched entry information as the candidate second party of first stage, and sends the first determination result to the client side corresponding to the candidate third party of first stage wherein the target information is intended to describe the demand specs of the target service, the entry information of the plurality of second parties comprises at least the identity information of the plurality of second party and the information of the plurality of second party associated with the demand specs of the target service, the candidate third parties are parties associated with the first party and/or the plurality of second parties, and the candidate third parties are intended to provide service support for the target service; the second determination unit 20 receives, through the server side, the first service support information sent by the client sides corresponding to the candidate third parties of first stage, obtains a second determination result by matching the first service support information with the entry information of the plurality of candidate second parties of first stage and determining the candidate third parties corresponding to the matched first service support information as the candidate third parties of second stage, and sends the second determination result to the client sides corresponding to the candidate second parties of first stage; the third determination unit 30 receives, through the server side, the first response message generated by the candidate second parties of first stage based on the first service support information, obtains a third determination result by matching the first response message with the target information and determining the candidate second parties corresponding to the matched first response message as the candidate second parties of second stage, and sends the third determination result to the client side corresponding to the first party; the fourth determination unit 40 receives, through the server side, the second parties of third stage determined by the client side corresponding to the first party from the candidate second parties of second stage, and determines the target second party from the second parties of third stage based on the second service support information sent by the third parties of second stage. Thereby, the problems that the bidding data is processed at a low efficiency in the related technology and it is difficult to determine a bidder matching the tender demand information accurately is solved. By collecting information from multiple parties and collaboratively processing their interaction information, determining a bidder that match the tender demand information of a single or multiple bidding scenarios efficiently and accurately is achieved.

The bidding apparatus comprises a processor and a memory, each of the units is stored in the memory as a program unit, and the processor executes the program units stored in the memory to achieve corresponding functions.

The processor contains a kernel, which retrieves the corresponding program units form the memory. There is at least one kernel. The problems that The kernel can be set one or more, and the problems that the bidding data is processed at a low efficiency in the related technology it is difficult to determine a bidder matching the tender demand information accurately is solved by adjusting parameters of the kernel.

Memory may comprises non-permanent memory in computer readable media, random access memory (RAM) and/or non-volatile memory in the form of read-only memory (ROM) or flash memory (flash RAM), where the memory comprises at least one memory chip.

### Embodiment Three

Embodiments of the present application further provide a non-volatile storage medium, the non-volatile storage medium comprising a stored program, wherein the program, when being executed, controls a device on which the non-volatile storage medium is located to perform an information processing method.

Embodiments of the present application further provide an electronic apparatus comprising a processor and a memory; wherein computer readable instructions are stored in the memory, and the processor is configured to execute the computer readable instructions, wherein the computer readable instructions execute an information processing method when run. The electronic apparatus herein may be a server, PC, PAD, cell phone, etc.

One of ordinary skill in the art should understand that embodiments of the present application may be implemented as methods, systems, or computer program products. Accordingly, the present application may take a form of an entirely hardware embodiment, an entirely software embodiment, or an embodiment combining software and hardware. Further, the present application may take a form of a computer program product implemented on one or more computer-usable storage media (comprising, but not limited to, disk memory, CD ROM, optical memory, etc.) containing computer-readable program code therein.

The present application is described with reference to flowcharts and/or block diagrams of methods, apparatuses (systems), and computer program products according to embodiments of the present application. It should be understood that each of the processes and/or boxes in the flowcharts and/or block diagrams, and the combination of the processes and/or boxes in the flowcharts and/or block diagrams, can be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes of the flowchart and/or one box or multiple boxes of the block diagram.

These computer program instructions may also be stored in a computer readable memory capable of causing a computer or other programmable data processing device to operate in a particular manner, such that the instructions stored in such computer readable memory produce an article of manufacture comprising an instruction device that implements the function specified in one or more processes of a flowchart and/or one or more boxes of a block diagram.

These computer program instructions may further be loaded onto a computer or other programmable data processing device such that a series of operational steps are executed on the computer or other programmable device to produce computer-implemented processing such that the instructions executed on the computer or other programmable device provide steps for implementing the functions specified in one or more processes of a flowchart and/or one or more boxes of a block diagram.

In a typical configuration, the computing device comprises one or more processors (CPUs), input/output interfaces, network interfaces, and memory.

Memory may comprise non-permanent memory in the form of computer readable media, random access memory (RAM) and/or non-volatile memory, such as read-only memory (ROM) or flash memory (flash RAM). Memory is an example of a computer readable medium.

Computer readable media comprising permanent and non-permanent, removable and non-removable media can be used by any method or technology to implement information storage. The information may be computer readable instructions, data structures, modules of a program, or other data. Examples of storage media for computers comprise, but are not limited to, phase change random access memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc only Read Memory (CD-ROM), Digital Versatile Disc (DVD) or other optical storage, magnetic cartridge tape, magnetic tape magnetic disk storage or other magnetic storage device or any other non-transmission medium that can be used to store information that can be accessed by a computing device. As defined herein, computer readable media does not include computer readable transitory media (transitory media), such as modulated data signals and carriers.

It is also important to note that the terms “includes,” “comprises,” or any other variation thereof are intended to cover non-exclusive inclusion, such that a process, method, commodity, or apparatus comprising a set of elements comprises not only those elements, but also other elements not expressly listed, or elements inherent to such process, method, commodity, or apparatus. Without further limitation, the inclusion of an element as defined by the statement “comprising a . . . ” does not preclude existence of additional identical elements in the process, method, article, or apparatus that comprises the elements.

It should be understood by one of ordinary skill in the art that embodiments of the present application may be provided as methods, systems, or computer program products. Accordingly, the present application may take the form of an entirely hardware embodiment, an entirely software embodiment, or an embodiment integrating software and hardware aspects. Further, the present application may take the form of a computer program product implemented on one or more computer readable storage media (comprising, but not limited to, disk memory, CD ROM, optical memory, etc.) containing computer readable program code therein.

The above is only an example of the present application, and is not intended to limit the present application. To one of ordinary skill in the art, this application may have various changes and variations. Any modification, equivalent replacement, improvement, etc. made within the spirit and principle of this application shall be included in the protection scope of the claims of this application.

### INDUSTRIAL APPLICABILITY

The solutions according to the embodiments of the present application is applicable to the technical field of data processing. In the embodiments of the present application, after receiving a target information sent by a first party, a server side determines candidate second parties of first stage by matching entry information of a plurality of second parties with the target information; after receiving a first service support information sent by candidate third parties of first stage, the server side determines candidate third parties of second stage by matching the first service support information with the entry information of the candidate second parties of first stage; after receiving a first response message generated by the candidate second parties of first stage; the server side determines candidate second parties of second stage by matching the first response message with the target information; and the server side receives second parties of third stage determined from the candidate second parties of second stage and determines a target second party. Through processing information by the information processing method, the problems that the bidding data is processed at a low efficiency in the related technology and it is difficult to determine a bidder matching the tender demand information accurately is solved.

1. An information processing method, comprising:
after receiving target information sent by a client side corresponding to a first party, a server side obtaining a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second parties comprises at least identity information of the plurality of second parties and information of the plurality of second parties associated with demand specs of the target service, the candidate third parties indicates parties associated with the first party and/or the second parties, and the candidate third parties are intended to provide service support for the target service;
after receiving first service support information sent by the client sides corresponding to the candidate third parties of first stage, the server side obtaining a second determination result by matching the first service support information with the entry information of the candidate second parties of first stage and determining candidate third parties corresponding to matched first service support information as candidate third parties of second stage, and sending the second determination result to client sides corresponding to the candidate second parties of first stage;
the server side obtaining a third determination result by receiving first response message generated by the candidate second parties of first stage based on the first service support information, matching the first response message with the target information, and determining candidate second parties corresponding to matched first response message as candidate second parties of second stage, and sending the third determination result to the client side corresponding to the first party; and
the server side receiving second parties of third stage determined by the client side corresponding to the first party from the candidate second parties of second stage, and determining a target second party from the second parties of third stage based on a second service support information sent by the third parties of second stage.

2. The information processing method according to claim 1, wherein the server side receiving the second parties of third stage determined by the client side corresponding to the first party from the candidate second parties of second stage, and determining the target second party from the second parties of third stage based on the second service support information sent by the third parties of second stage comprises:
the server side obtaining a fourth determination result by receiving second parties of third stage determined by the client side corresponding to the first party from the candidate second parties of second stage, and sending the fourth determination result to client sides corresponding to the second parties of third stage;
the server side receiving second response message sent by the second parties of third stage and sending the second response message to client sides corresponding to the candidate third parties of second stage;
the server side receiving second service support information sent by the candidate third parties of second stage in response to the second response message and sending the second service support information to the second parties of third stage; and
the server side receiving confirmation information sent by a client side corresponding to at least one second party of the second parties of third stage and determining the at least one second party sending the confirmation information as the target second party.

3. The information processing method according to claim 1, wherein after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises:
the server side receiving entry information sent by client sides corresponding to a plurality of parties, the plurality of parties comprising at least: the first party, the plurality of second parties and a plurality of third parties, wherein the entry information comprises at least identity information of the plurality of parties and information of the plurality of parties associated with demand specs of the target service; and
the server side verifying the entry information of the plurality of parties and obtaining an information set consisting of entry information of the plurality of parties that pass verification, and sending the information set to a client side corresponding to each of the plurality of parties.

4. The information processing method according to claim 1, wherein after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises:
the server side receiving identity information sent by client sides corresponding to a plurality of parties and receiving device information uploaded via Internet by sensing devices associated with the plurality of parties, wherein the plurality of parties comprises at least: the first party, the plurality of second parties, and a plurality of third parties, wherein the device information indicates information associated with demand specs of the target service; and
the server side obtaining entry information of the plurality of parties by verifying identity information of each party of the plurality of parties and the device information uploaded by the sensing devices associated with each party of the plurality of parties, and sending an information set consisting of the entry information of the plurality of parties to client sides corresponding to each of the plurality of parties.

5. The information processing method according to claim 1, wherein during determining the second parties of first stage, determining the second parties of second stage and determining the second parties of third stage, a first notification message is sent to the client side corresponding to the first party and to client sides corresponding to the second parties in each stage that entered a next stage, respectively, and a second notification message is sent to client sides corresponding to the second parties in each stage that failed to enter the next stage, respectively; wherein the first notification message comprises information about all second parties of a current stage that entered the next stage, and the second notification message indicates that the second party in the current stage failed to enter the next stage.

6. An information processing method according to claim 1, wherein after receiving target information sent by the client side corresponding to the first party, and before the server side obtaining the first determination result by matching stored entry information of the plurality of second parties with the target information and determining the second parties corresponding to the matched entry information as the candidate second parties of first stage, the method further comprises:
the server side receiving entrustment information of the first party and/or the plurality of second parties and determining, based on the entrustment information, a fourth party corresponding to the first party and/or fifth parties corresponding to the plurality of second parties, respectively; and
during the first stage, the second stage, and the third stage, in a case that the server side receives the entrustment information of the first party, the fourth party processes information to be processed the first party on behalf of the first party, and in a case that the server side receives an entrustment information from one of the second parties, the fifth objet processes information to be processed by the one of the second parties on behalf of the one of the second parties.

7. The information processing method according to claim 1, wherein after receiving the target information sent by the client side corresponding to the first party, and before the server side obtaining the first determination result by matching stored entry information of the plurality of second parties with the target information and determining the second parties corresponding to the matched entry information as the candidate second parties of first stage, the method further comprises:
receiving, through an independent financial service provider, digital currency deposited by the plurality of second parties; and
refunding the digital currency deposited by the second parties in each stage that failed to enter a next stage during determining the second parties of first stage, determining the second parties of second stage, and determining the second parties of third stage.

8. An information processing method according to claim 7, whereinafter receiving the target information sent by the client side corresponding to the first party, and before the server side obtaining the first determination result by matching stored entry information of the plurality of second parties with the target information and determining the second parties corresponding to the matched entry information as the candidate second parties of first stage, the method further comprises receiving, through an independent financial service provider, digital currency deposited by the first party;
after the server side receiving the second party of third stage determined by the client side corresponding to the first party from the candidate second party of second stage, and determining the target second party from the second party of third stage based on the second service support information sent by the third party of second stage, the method further comprises:
during the target second party providing the target service indicated by the target information, determining whether behavior of the first party complies with the first predetermined rules and determining whether the target second party complies with the second predetermined rules;
in a case that the behavior of the first party complies with the first predetermined rules, paying, through the independent financial service provider, digital currency deposited the target second party that fails to comply with the second predetermined rules to the first party and refunding through the independent financial service provider the digital currency deposited by the target second party that complies with the second pre-determined rules; and
in a case that the behavior of the first party fails to comply with the first pre-determined rules, refunding through the independent financial service provider the digital currency deposited by the target second party that complies with the second pre-determined rules, and paying through the independent financial service provider the digital currency deposited by the first party to the target second party that complies with the second predetermined rules.

9. An information processing method according to claim 1, wherein after the server side receiving the second parties of third stage determined by the client side corresponding to the first party from the candidate second parties of second stage, and determining the target second party from the second parties of third stage based on the second service support information sent by the third parties of second stage, the method further comprises:
the server side receiving demand information sent by the first party and/or the target second party and determining a sixth party based on the demand information, such that the sixth party provides the service indicated by the demand information; and
the server side receiving supply information sent by the first party and/or the target second party and determining a seventh party based on the supply information such that service indicated by the supply information is provided for the seventh party.

10. The information processing method according to claim 1, wherein after receiving information sent by a target client side, the server side determines a first language in which the received information is expressed and determines whether the first language is a predetermined language, wherein the target client side is a client side corresponding to at least one of the following parties: the first party, the second party and the third party;
in a case that the first language is not the predetermined language, the server side converting the received information into information expressed in the predetermined language and obtaining meaning of the converted information through semantic understanding;
after obtaining the information to be sent to the target client side, the server side converting the information to be sent to the target client side into information expressed in the first language and sending the converted information to be sent to the target client side, and sending the converted information to the target client side.

11. An information processing apparatus, comprising:
a first determination unit, configured to receive target information sent by a client side corresponding to a first party through a server side, and to obtain a first determination result by matching stored entry information of a plurality of second parties with the target information and determining second parties corresponding to matched entry information as candidate second parties of first stage, and sending the first determination result to client sides corresponding to candidate third parties of first stage, wherein the target information is intended to describe demand specs of target service, the entry information of the plurality of second parties comprises at least identity information of the plurality of second parties and information of the plurality of second parties associated with the demand specs of the target service, the candidate third parties indicates parties associated with the first party and/or the plurality of second parties, and the candidate third parties are intended to provide service support for the target service;
a second determination unit, configured to obtain, after receiving first service support information sent by client sides corresponding to the candidate third parties of first stage, a second determination result by matching the first service support information with entry information of the candidate second parties of first stage and determining candidate parties corresponding to matched first service support information as candidate third parties of second stage, and to send the second determination result to client sides corresponding to the candidate second parties of first stage;
a third determination unit, configured to obtain a third determination result by receiving, through the server side, first response message generated by the candidate second parties of first stage based on the first service support information, matching the first response message with the target information and determining candidate second parties corresponding to matched first response message as candidate second parties of second stage, and sending the third determination result to the client side corresponding to the first party; and
a fourth determination unit, configured to receive, by the server side, a second parties of third stage determined by the client side corresponding to the first party from the candidate second parties of second stage, and to determine a target second party from the second parties of third stage based on second service support information sent by the third parties of second stage.
